(19) United States
(12) Patent Application Publication
(10) Pub. No.: US 2003/0020850 A1
(43) Pub. Date: Jan. 30, 2003

(54) Reflective display and portable information appliance

(76) Inventors: Akihiro Funamoto, Kyoto-shi (JP); Shigeru Aoyama, Kyoto-shi (JP)

Correspondence Address: ROSENTHAL & OSHA L.L.P., Suite 2800, 1221 McKinney Street, Houston, TX, 77010, US

(21) Appl. No.: 10/194,928

(22) Filed: Jul. 12, 2002

(30) Foreign Application Priority Data
Jul. 19, 2001 (JP) 220182/2001

(51) Int. Cl. G02F 1/1335

(52) U.S. Cl. 349/65

(57) ABSTRACT

The invention presents a reflective display and a portable information appliance capable of preventing lowering of image quality and contrast by not forming pattern in the front light. The reflective display comprises a light guide plate 109 for guiding the light from a light source 110, reflective ruggedness 107 for reflecting the light entering from the light guide plate 109, and a liquid crystal layer 106 for controlling the exit of light, in which the polarizing characteristics of the liquid crystal layer 106 is set so that the transmissivity of the incident light entering from a direction different from the vertical direction of the liquid crystal layer 106 maybe an optimum value.

### BACKGROUND OF THE INVENTION

1. Field of the Invention

The present invention relates to a reflective display, and a portable information appliance using this reflective display.

2. Description of the Related Art

A conventional reflective display requires a front light in order to recognize the image visually when the surrounding is dark.

For the observer, it is the most comfortable to observe the image displayed on the reflective display from the front.

Accordingly, for the observer to recognize the image from the front, a pattern is formed in a conventional front light for emitting guided light vertically to a reflective ruggedness. This conventional reflective display is explained referring to FIG. 12.

As shown in FIG. 12, the conventional reflective display comprises a front light 1101 composed of a light guide plate 1109 and a light source 1110, a polarizer 1102, a quarter wavelength plate 1103, an upper substrate 1104, a liquid crystal layer 1105 of thickness d′, reflective ruggedness 1106, and a lower substrate 1107, which are laminated sequentially.

A pattern 1111 is formed on the surface of the light guide plate 1109, and this pattern 1111 is positioned at the closest side to the observer of the reflective display. Accordingly, the pattern 1111 is easily visible to the observer 1108, and the image quality is lowered.

That is, the light from the light source 1110 leaks to the observer side from the pattern 1111, and is visible to the observer 1108, and the contrast is lowered.

The invention is devised in the light of the above background, and it is hence an object thereof to present a reflective display and a portable information appliance capable of preventing lowering of image quality or contrast, by not forming pattern on the surface of the front light.

### SUMMARY OF THE INVENTION

To achieve the object, the reflective display of the invention comprises a light guide plate for guiding the light from a light source, a reflection layer for reflecting the incident light from the light guide plate, and a liquid crystal layer disposed between the light guide plate and the reflection layer, in which the polarizing characteristics of the liquid crystal layer is set so that the transmissivity of the light emitted from the light guide plate and entering the liquid crystal layer from a direction different from the vertical direction of the liquid crystal layer may be an optimum value.

Preferably, the polarizing characteristics of the liquid crystal layer is set by the thickness of the liquid crystal layer.

Preferably, the thickness d of the liquid crystal layer satisfies the formula=2d′/(1+1/cos θ) where θ is the incident angle of the light in the liquid crystal layer, and d′ is the thickness of the liquid crystal layer when the transmissivity of the light entering the liquid crystal layer vertically may be an optimum value.

Preferably, the polarizing characteristics of the liquid crystal layer is set by the birefringence of the liquid crystal layer.

Preferably, the birefringence Δn of the liquid crystal layer satisfies the formula Δn=2Δn′/(1+1/cos θ) where θ is the incident angle of the light in the liquid crystal layer, and Δn′ is the birefringence of the liquid crystal layer when the transmissivity of the light entering the liquid crystal layer vertically may be an optimum value.

Preferably, the polarizing characteristics of the liquid crystal layer is set by the driving voltage of the liquid crystal layer.

Preferably, the driving voltage is controlled depending on the opportunity of lighting of the light source.

Preferably, the display further comprises a sensor for detecting an external light entering the reflective display, in which the polarizing characteristics of the liquid crystal layer is set by the driving voltage of the liquid crystal layer on the basis of the detection result of the sensor.

Preferably, the following formula x+y≦100 is satisfied, where x is the transmissivity in percentage of the light which enters the liquid crystal display from the light source and is emitted from the liquid crystal layer and is the transmissivity in percentage of the external light which enters the liquid crystal display and is emitted from the liquid crystal layer.

Preferably, the polarizing characteristics of the liquid crystal layer is set so that the transmissivity of the light entering from a direction different from the vertical direction of the liquid crystal layer may be the lowest.

Preferably, the polarizing characteristics of the liquid crystal layer is set so that the transmissivity of the light entering from a direction different from the vertical direction of the liquid crystal layer may be the highest.

The portable information appliance of the invention is characterized by employing the reflective display mentioned above.

Herein, a typical example of the reflective display of the invention uses the so-called liquid crystal display panel having a liquid crystal layer formed inside for generating an image by making use of the characteristics of the liquid crystal layer, but not limited to this.

The liquid crystal display method of the invention is a liquid crystal display method for displaying an image by using a reflective display comprising a light guide plate for guiding the light from a light source, a reflection layer for reflecting the incident light from the light guide plate, and a liquid crystal layer disposed between the light guide plate and the reflection layer, in which the polarizing characteristics of the liquid crystal layer is set so that the transmissivity of the light emitted from the light guide plate and entering the liquid crystal layer from a direction different from the vertical direction of the liquid crystal layer may be an optimum value.

Herein, the external light refers to the light other than the light from the front light, such as direct sunlight, illuminating light, or ambient light. Usually, the display screen is designed to be seen from the front side, and the external light enters from a direction nearly vertical to the front face of the reflective display, and the external light reflected on the reflection plane is emitted in a direction vertical to the front face. However, the incident angle of external light is not limited, and may enter obliquely from the front face of the reflective display panel. On the other hand, the incident light from the front light entered at a specific angle to the vertical direction of the liquid crystal layer.

The direction of reflecting the external light may be controlled by adjusting the slope of the rugged pattern for reflecting the incident light from the light source by making asymmetric the rugged pattern for reflecting the incident external light, so that the direction of reflecting the incident light from the light source may be different from the vertical reflection direction of external light on the surface of the reflective display panel. It hence prevents failure of viewing of image due to the light vertically reflected on the surface of the reflective display panel.

The polarizing characteristics of the liquid crystal layer refers to the rate of change of polarized state given on the light propagating in the liquid crystal layer, or the property of giving such change in the polarized state. This polarizing characteristics varies depending on, for example, the thickness of the liquid crystal layer, birefringence of the liquid crystal layer, and driving voltage applied to the liquid crystal layer.

The transmissivity refers to the ratio of the intensity of exit light to the intensity of the incident light, when the light entering the reflective display is reflected and emitted from the reflective display.

The optimum value of the transmissivity of the light entering the liquid crystal layer (the light emitted from the reflective display) may be either the lowest value of the transmissivity as in the case of normally black or the highest value of the transmissivity as in the case of normally white, or depending on the state of use, appropriately, the optimum value maybe an arbitrary intermediate value between the highest value and lowest value of the transmissivity.

### BRIEF DESCRIPTION OF THE DRAWINGS

FIG. 1 shows a reflective display in a first embodiment of the invention in a general schematic sectional view.

FIG. 2 shows reflective ruggedness 107 in FIG. 1 in a perspective view.

FIG. 3 shows schematically a first pattern 202 in FIG. 2.

FIG. 4 shows schematically a second pattern 203 in FIG. 2.

FIG. 5 shows a reflective display to explain third to fifth embodiments of the invention.

FIG. 6 shows a reflective display in a sixth embodiment of the invention in a general schematic sectional view.

FIG. 7 shows a reflective display in a seventh embodiment of the invention in a general schematic sectional view.

FIG. 8 shows a mobile phone employing any one of the reflective displays in the first to seventh embodiments of the invention.

FIG. 9 shows a portable information terminal employing any one of the reflective displays in the first to seventh embodiments of the invention.

FIG. 10 shows a mobile computer employing any one of the reflective displays in the first to seventh embodiments of the invention.

FIG. 11 shows a television receiver employing any one of the reflective displays in the first to seventh embodiments of the invention.

FIG. 12 shows a first example of conventional reflective display having a light guide plate forming a pattern for emitting the light vertically to the reflective ruggedness.

### DESCRIPTION OF THE PREFERRED EMBODIMENTS

Referring now to the drawings, preferred exemplary embodiments of the invention are described in detail below. Dimensions, materials, shape, and relative configuration of the component parts described in the embodiments are not intended to limit the scope of the invention unless otherwise noted.

In the following drawings, the same reference numerals are given to the corresponding members mentioned in the foregoing drawings.

(First Embodiment of Reflective Display)

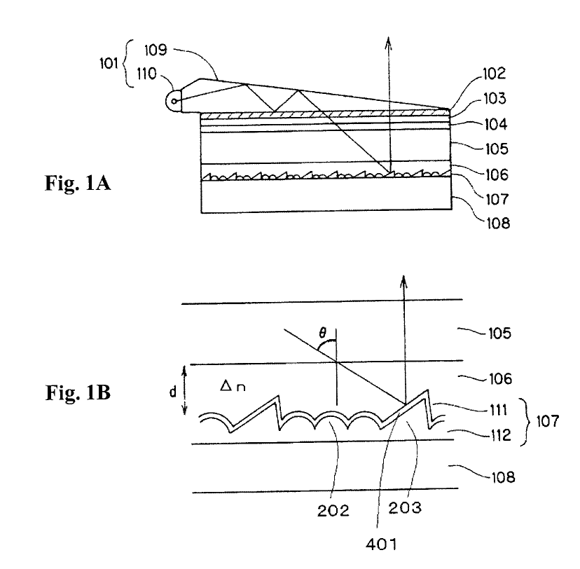

FIG. 1A is a general schematic sectional view of a reflective display in a first embodiment of the invention. FIG. 1B is a partially magnified view of FIG. 1A.

As shown in FIG. 1A, the first embodiment of the reflective display of the invention comprises a front light 101, an adhesive 102, a polarizer 103, a quarter wavelength plate 104, an upper substrate 105, a liquid crystal layer 106, reflective ruggedness 107, and a lower substrate 108, which are laminated sequentially. However, the quarter wavelength plate 104 may not be always required.

Although not shown in FIG. 1, a liquid crystal drive unit is provided above or beneath the liquid crystal layer 106.

In the case of a color reflective display, a color filter is disposed above or beneath the liquid crystal layer 106.

The front light 101 is composed of a light guide plate 109 for guiding the light to the side of the reflective ruggedness 107, and a light source 110 for emitting light. In the front light 101, pattern is not formed on the surface, but the thickness is reduced as going away from the light source 110 (wedge shape). This wedge shape is suited to guiding of the light from the light source 110 uniformly to the side of the reflective ruggedness 107.

The adhesive 102 is to adhere the light guide plate 109 and the polarizer 103. The adhesive 102 may be formed of a tacky material. The refractive index of the adhesive 102 should be preferably smaller than the refractive index of the light guide plate 109. Therefore, the light can be emitted efficiently from the front light 101 to the reflective ruggedness 107.

The polarizer 103 converts the incident light into a linear polarized light.

The quarter wavelength plate 104 gives an optical path difference which equals to quarter wavelength when linear polarized light passes through it oscillating mutually in vertical directions.

The liquid crystal layer 106 is a crystalline liquid showing optical anisotropy such as birefringence. The birefringence of this liquid crystal layer 106 is supposed to be Δn.

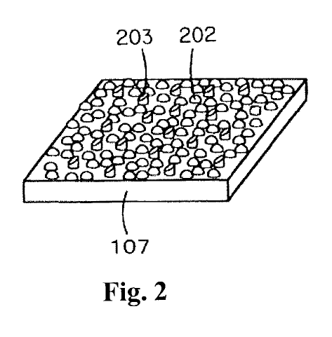

The reflective ruggedness 107 are a member for reflecting the incident light, and is composed of a reflection layer 111 and an rugged layer 112 formed of a material of high reflectivity such as aluminum or silver. The reflective ruggedness 107 are further described by referring to FIG. 2 to FIG. 4.

FIG. 2 is a perspective view of the reflective ruggedness 107 shown in FIG. 1. The reflective ruggedness 107 are composed of first multiple fine patterns 202 for reflecting the external light, and second multiple fine patterns 203 for reflecting the light from the front light 101. In FIG. 2, the first patterns 102 and second patterns 203 are shown sparsely, but actually both patterns are formed densely without gap in order to enhance the light utilization efficiency.

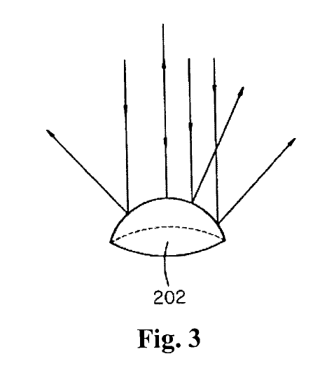

FIG. 3 is a schematic diagram of the first pattern 202 shown in FIG. 2. The first pattern 202 is formed spherically in order to spread and reflect the external light entering vertically to the reflective ruggedness.

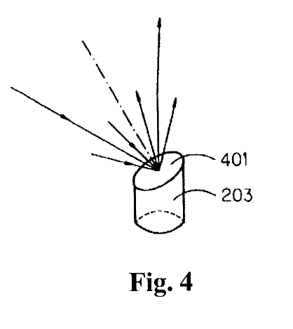

FIG. 4 is a schematic diagram of the second pattern 203 shown in FIG. 2. The second pattern 203 is formed like a post having a slope 401 on the top. The slope 401 is defined in its shape in order to reflect the light from the front light 101 in a direction nearly vertical to the reflective display. The shape of the second pattern 203 is arbitrary, including circular column, truncated cone, and square column.

The optical path in the embodiment is explained. The light emitted from the light source 101, guided by the light guide plate 109, and emitted obliquely from the lower side of the light guide plate passes through the adhesive 102, polarizer 103, quarter wavelength plate 104, upper substrate 105, and liquid crystal layer 106, and reaches the reflective ruggedness 107. Of the light reaching the reflective ruggedness 107, the light reflected by the second patterns 203 is emitted almost vertically ahead of the reflective display.

Herein, when the light enters nearly vertically to the reflective ruggedness 107, and is emitted almost vertically after being reflected by the reflective ruggedness 107, the polarizing characteristics of the liquid crystal layer is adjusted vertically. For example, since the light reciprocates in thickness d′ of the liquid crystal layer, the transmissivity of the liquid crystal is set so as to be lowest in the optical path length of 2d′.

However, as in this embodiment, when the light enters at a specific angle to the vertical direction of the liquid crystal layer, the optical path length of the light is elongated, and the polarization rotates excessively.

In this embodiment, the polarizing characteristics of the liquid crystal layer 106 is set so that the transmissivity of the light may be the lowest when the light emitted from the front light 101 enters the liquid crystal layer 106 as being inclined by angle θ with respect to the vertical direction of the liquid crystal layer 106. Specifically, the polarizing characteristics of the liquid crystal layer 106 is set depending on the thickness d of the liquid crystal layer 106. This setting is suited, for example, to the liquid crystal display of normally black type.

Setting of the thickness d of the liquid crystal layer 106 is explained. For example, supposing the thickness of the liquid crystal layer 106 to be d′ in the case the transmissivity T of the light is the lowest when the light enters the liquid crystal layer 106 vertically, when the light enters at an inclination of angle θ to the vertical direction of the liquid crystal layer 106, the thickness d of the liquid crystal layer 106 should satisfy

2d′=(1+1/cos θ)

Therefore, d should be set to satisfy

d=2d′/(1+1/cos θ)

Herein, however, the term “the lowest transmissivity” or “the highest transmissivity” does not refer strictly to the maximum value or minimum value of the transmissivity, but is an approximate concept including values near the maximum value or minimum value. Practically, for example, there is no problem if an allowance is within plus or minus 10% of the maximum value or minimum value.

In the reflective display of the embodiment shown in FIG. 1, since the liquid crystal layer 106 is in contact with the reflective ruggedness 107, the thickness d of the liquid crystal layer 106 varies depending on the position (x, y) in the reflective display.

In this case, the thickness d of the liquid crystal layer 106 is given as the average thickness of the liquid crystal layer 106. That is, in terms of position (x, y) in the reflective display, distance t (x, y) from the upper substrate 105 to the reflective ruggedness 107, and area (area of liquid crystal 106) S of the reflective display, it is expressed as follows.

d=∫∫t(x,y)/S(dxdy (1)

In this embodiment, however, the value of d is not limited to this strictly calculated value of d, but an arbitrary value may be set properly so as not to have effects on execution of the invention.

Thus, by using the front light which has no pattern formed on the surface, lowering of picture quality or contrast can be prevented.

(Second Embodiment of Reflective Display)

A second embodiment of the reflective display of the invention is explained below by referring to FIG. 1, same as in the case of the first embodiment.

In this embodiment, the polarizing characteristics of the liquid crystal layer 106 is set depending on the birefringence Δn of the liquid crystal layer 106.

Setting of the birefringence Δn of the liquid crystal layer 106 is explained. For example, supposing the birefringence of the liquid crystal layer 106 to be Δn′ when the transmissivity T of the light is the lowest in the case of vertical input of the light to the liquid crystal layer 106 of thickness d, when the light enters as being inclined by angle θ to the vertical direction of the liquid crystal layer 106 of thickness d, the birefringence Δn of the liquid crystal layer 106 should satisfy

2Δn′d=Δn(1+1/cos θ)d

Therefore, Δn should be set to satisfy

Δn=2Δn′/(1+1/cos θ)

Thus, the polarizing characteristics of the liquid crystal layer 106 can be set also by the birefringence Δn of the liquid crystal layer 106, so that the same effects as in the first embodiment may be obtained.

(Third Embodiment of Reflective Display)

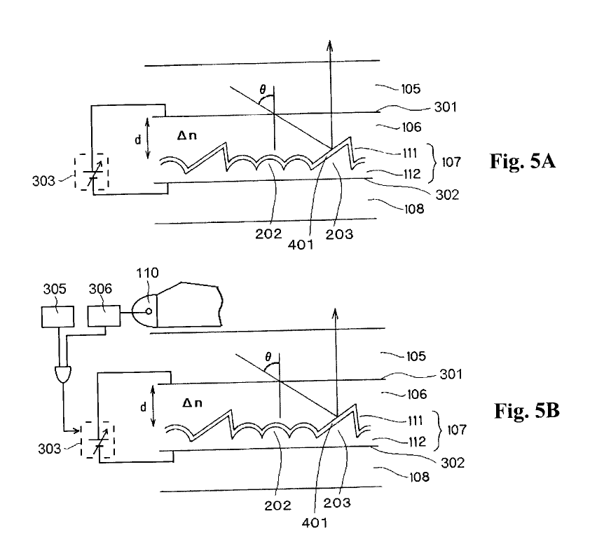

A third embodiment of the reflective display of the invention is explained below by referring to FIG. 5A.

In this embodiment, liquid crystal drive electrodes 301, 302 are disposed above and beneath the liquid crystal layer 106 in the foregoing embodiments in FIG. 1A, and a liquid crystal drive power source 303 for applying a driving voltage V is disposed between the liquid crystal drive electrodes 301, 302.

In such configuration, the polarizing characteristics of the liquid crystal layer 106 is set also by the driving voltage V applied to the liquid crystal layer 106, so that the same effects as in the foregoing embodiments may be obtained.

(Fourth Embodiment of Reflective Display)

A fourth embodiment of the reflective display of the invention is explained below by referring to FIG. 5A same as in the preceding embodiment.

In the fourth embodiment, when using both the light from the front light and the external light, the transmissivity of each light is combined and set.

For example, anyone of the thickness d of the liquid crystal layer 106, the birefringence Δn of the liquid crystal layer 106, and the driving voltage V of the liquid crystal layer 106 is set so that the transmissivity may be 50% in the case of external light, and that the transmissivity may be 50% in the case of the light from the front light.

Herein, the transmissivity x of the light from the front light and the transmissivity y of the external light may be arbitrary values satisfying the relation of x+y≦100. For instance, when the external light has the stronger illumination than the light from the front light, the transmissivity of the external light may be set at 30%, and the transmissivity of the light from the front light may be set at 70%.

Thus, the transmissivities of the light from the front light and the external light can be set by combination of the two, so that the same effects as in the first embodiment may be obtained.

(Fifth Embodiment of Reflective Display)

A fifth embodiment of the reflective display of the invention is explained below by referring to FIG. 5B. In this embodiment, the liquid crystal drive power source 303 of the liquid crystal layer 106 in FIG. 5A of the preceding embodiment is designed to be controllable by an external light sensor 305 or a lighting system sensor 306.

In this embodiment, same as in the fourth embodiment, the polarizing characteristics of the liquid crystal layer 106 is set by the driving voltage V of the liquid crystal layer 106. This embodiment, different from the fourth embodiment, controls the driving voltage V depending on the opportunity of lighting by the front light or lighting by external light.

For example, when the front light 101 begins to light, the lighting system sensor 306 detects that the power source of the front light 101 is turned on, and starts control of the driving voltage. Or, when lighting of the front light 101 starts, the driving voltage may be controlled manually.

Alternatively, by installing an external light sensor 305 in the reflective display or in an applied device of the reflective display, the driving voltage V may be controlled on the basis of the detection result by this external light sensor 305. On the opportunity when sufficient external light is not detected by the external light sensor, the driving voltage V to be applied to the liquid crystal layer 106 is controlled.

The driving voltage is controlled so that the driving voltage may be lower when displaying by the light from the front light 101 as compared with the driving voltage when displaying by the external light.

Thus, the polarizing characteristics of the liquid crystal layer 106 can be set also by the driving voltage V applied to the liquid crystal layer 106, so that the same effects as in the foregoing embodiments may be obtained.

(Sixth Embodiment of Reflective Display)

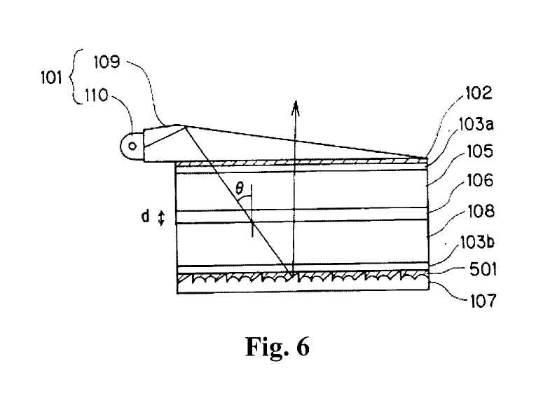

A sixth embodiment of the reflective display of the invention is explained below by referring to FIG. 6.

The reflective display of this embodiment is different from the foregoing reflective displays in its structure.

The reflective display of the sixth embodiment comprises, as shown in FIG. 6, a front light 101 composed of a light guide plate 109 and a light source 110, an adhesive 102, a polarizer 103a, an upper substrate 105, a liquid crystal layer 106, a lower substrate 108, a polarizer 103b, an adhesive 501, and reflective ruggedness 107, which are laminated sequentially.

Thus, if the reflective ruggedness 107 are disposed on the lowest side of the reflective display, the same effects as in the foregoing embodiments are obtained. Besides, by designing a structure in which the reflective ruggedness 107 are adhered to the lower side of the lower substrate of the reflective display, the degree of freedom of design of the reflective display may be enhanced.

(Seventh Embodiment of Reflective Display)

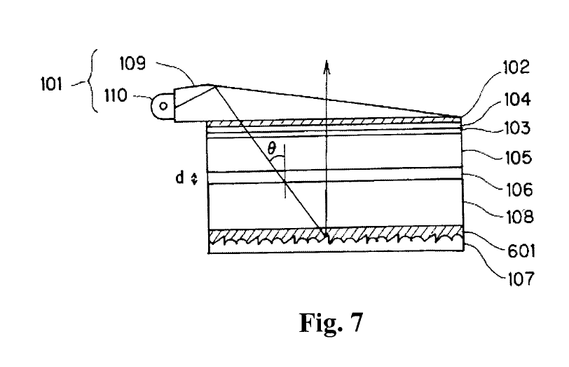

A seventh embodiment of the reflective display of the invention is explained below by referring to FIG. 7.

The reflective display of this embodiment is different from the foregoing reflective displays in its structure.

The reflective display of the seventh embodiment comprises, as shown in FIG. 7, a front light 101 composed of a light guide plate 109 and a light source 110, an adhesive 102, a quarter wavelength plate 104, a polarizer 103, an upper substrate 105, a liquid crystal layer 106, a lower substrate 108, an adhesive 601, and reflective ruggedness 107, which are laminated sequentially.

Thus, if the reflective ruggedness 107 are disposed on the lowest side of the reflective display, the same effects as in the foregoing embodiments are obtained. Besides, by designing a structure in which the reflective ruggedness 107 are adhered to the lower side of the lower substrate of the reflective display, the degree of freedom of design of the reflective display may be enhanced.

In this embodiment, the polarizing characteristics of the liquid crystal layer 106 is set so that the transmissivity T of the light maybe the lowest value, but, instead, the polarizing characteristics of the liquid crystal layer 106 is set so that the transmissivity T of the light may be the highest value. In this case, it is suited, for example, to the liquid crystal display of normally white type.

The foregoing embodiments may be properly combined as far as possible.

(Portable Information Appliance Using the Reflective Display)

A portable information appliance employing a reflective display of the invention is explained below by referring to the accompanying drawings.

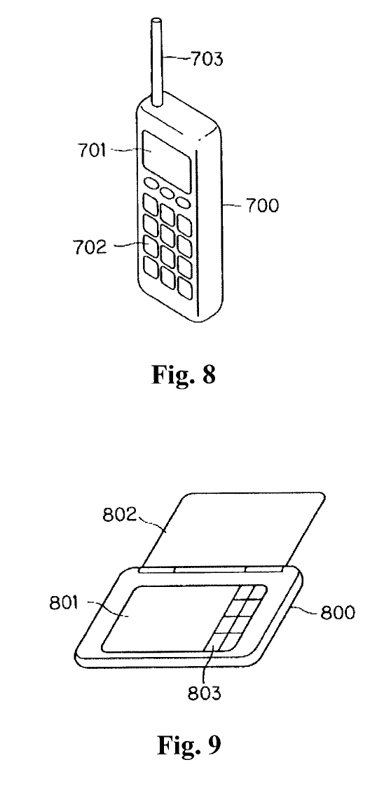

FIG. 8 is a schematic diagram of a mobile phone employing a reflective display in anyone of the first to seventh embodiments of the invention. As shown in FIG. 8, a mobile phone 700 as a portable information appliance within the scope of the claims of the present invention comprises a display unit 701, a dial 702, and an antenna 703.

The display unit 701 is realized by one of the embodiments of the reflective display of the invention, and hence the mobile phone has the same effects as in the foregoing embodiments.

FIG. 9 is a schematic diagram of a portable information terminal employing a reflective display in any one of the first to seventh embodiments of the invention. As shown in FIG. 9, a portable information terminal 800 as the portable information appliance within the scope of the claims of the present invention comprises a display unit 801, a cover 802, and an input unit 803.

The display unit 801 is realized by one of the embodiments of the reflective display of the invention, and hence the portable information terminal has the same effects as in the foregoing embodiments.

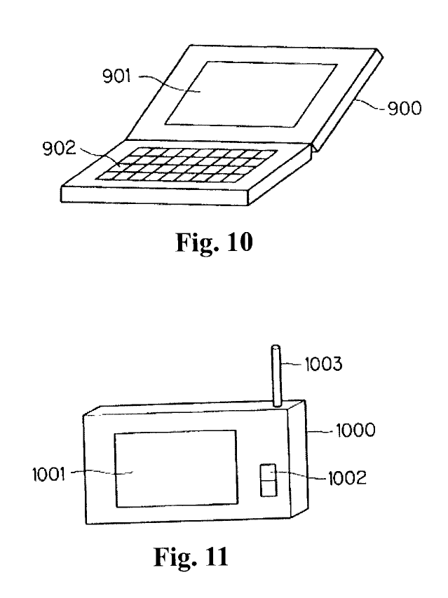

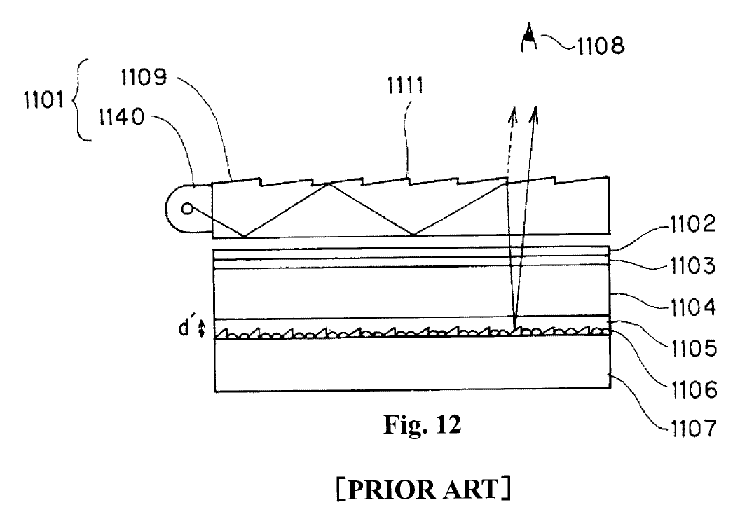

FIG. 10 is a schematic diagram of a mobile computer employing a reflective display in any one of the first to seventh embodiments of the invention. As shown in FIG. 10, a mobile computer 900 such as a laptop computer as the portable information appliance within the scope of the claims of the present invention comprises a display unit 901 and a keyboard 902.

The display unit 901 is realized by one of the embodiments of the reflective display of the invention, and hence the mobile computer has the same effects as in the foregoing embodiments.

FIG. 11 is a schematic diagram of a television receiver employing a reflective display in any one of the first to seventh embodiments of the invention. As shown in FIG. 11, a television receiver 1000 as the portable information appliance within the scope of the claims of the present invention comprises a display unit 1001, a tuner 1002, and an antenna 1003.

The display unit 1001 is realized by one of the embodiments of the reflective display of the invention, and hence the television receiver has the same effects as in the foregoing embodiments.

Thus, as described herein, by using the front light not forming pattern on the surface according to the invention, and setting the polarizing characteristics of the liquid crystal layer by at least one of the thickness of the liquid crystal layer, the birefringence of the liquid crystal layer, and the driving voltage of the liquid crystal layer, the reflective display and portable information appliance capable of preventing decline of image quality and contrast can be presented.

What is claimed is:

1. A reflective display comprising:
a light guide plate for guiding the light from a light source,
a reflection layer for reflecting the incident light from said light guide plate, and
a liquid crystal layer disposed between said light guide plate and said reflection layer,
wherein the polarizing characteristics of said liquid crystal layer is set so that the transmissivity of the light entering the liquid crystal layer from a direction different from the vertical direction of the liquid crystal layer may be an optimum value.

2. The reflective display of claim 1, wherein the polarizing characteristics of the liquid crystal layer is set by the thickness of the liquid crystal layer.

3. The reflective display of claim 2, wherein the thickness d of the liquid crystal layer satisfies the formula
d=2d′/(1+1/cosθ)
where θ is the incident angle of the light in the liquid crystal layer, and d′ is the thickness of the liquid crystal layer when the transmissivity of the light entering the liquid crystal layer vertically may be an optimum value.

4. The reflective display of claim 1, wherein the polarizing characteristics of the liquid crystal layer is set by the birefringence of the liquid crystal layer.

5. The reflective display of claim 4, wherein the birefringence Δn of the liquid crystal layer satisfies the formula
Δn=2Δn′/(1+1/cosθ)
where θ is the incident angle of the light in the liquid crystal layer, and Δn′ is the birefringence of the liquid crystal layer when the transmissivity of the light entering the liquid crystal layer vertically may be an optimum value.

6. The reflective display of claim 1, wherein the polarizing characteristics of the liquid crystal layer is set by the driving voltage of the liquid crystal layer.

7. The reflective display of claim 6, wherein the driving voltage is controlled depending on the opportunity of lighting of the light source.

8. The reflective display of claim 6, further comprising a sensor for detecting an external light entering the reflective display, wherein the polarizing characteristics of the liquid crystal layer is set by the driving voltage of the liquid crystal layer on the basis of the detection result of said sensor.

9. The reflective display of claim 1, wherein the following formula is satisfied
x+y≦100
where x is the transmissivity in percentage of the light which enters the liquid crystal display from the light source and is emitted from the liquid crystal layer and y is the transmissivity in percentage of the external light which enters the liquid crystal display and is emitted from the liquid crystal layer.

10. The reflective display of claim 1, wherein the polarizing characteristics of the liquid crystal layer is set so that the transmissivity of the light entering from a direction different from the vertical direction of the liquid crystal layer may be the lowest.

11. The reflective display of claim 1, wherein the polarizing characteristics of the liquid crystal layer is set so that the transmissivity of the light entering from a direction different from the vertical direction of the liquid crystal layer may be the highest.

12. A portable information appliance characterized by employing the reflective display of claim 1.

13. A liquid crystal display method for displaying an image by using a reflective display comprising:
a light guide plate for guiding the light from a light source,
a reflection layer for reflecting the incident light from said light guide plate, and
a liquid crystal layer disposed between said light guide plate and said reflection layer,
wherein the polarizing characteristics of said liquid crystal layer is set so that the transmissivity of the light emitted from said light guide plate and entering the liquid crystal layer from a direction different from the vertical direction of the liquid crystal layer may be an optimum value.
